(19) United States
(12) Patent Application Publication
(10) Pub. No.: US 2006/0048555 A1
(43) Pub. Date: Mar. 9, 2006

(54) Natural fertiliser and method for producing the same

(76) Inventor: Andreas Kummer, Grimma (DE)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 10/521,001

(22) PCT Filed: Jul. 9, 2003
(86) PCT No.: PCT/EP03/07413

§ 371 Date: Jul. 13, 2005

(30) Foreign Application Priority Data
Jul. 9, 2002 (DE) 102319103
Jul. 9, 2002 (DE) 202115828

(51) Int. Cl. C05F 3/00

(52) U.S. Cl. 71/15

(57) ABSTRACT

The invention relates to a drillable natural fertiliser and to a method for producing the same. The object of the invention is to describe or to characterize a natural fertiliser based on horse manure and a method for producing said fertiliser, which is simple, cost-effective and ecologically harmless and has good application properties. To this end, a natural fertiliser is produced, consisting of formed and dried horse droppings. The method for producing said fertiliser is characterized in that the horse droppings (manure excreted by horses) are collected and processed within a specific time frame.

The present invention relates to a natural fertiliser and to a method for producing the same in accordance with the preamble of claims 1 and 22 or 43.

The intensive use of agricultural and horticultural areas requires fertilisers to be added. Mineral fertilisers added can compensate for the used up nutrients. Fertilizing exclusively on the basis of mineral fertilisers has, however, the disadvantage that no organic substance is supplied to the intensively used soil. Organic substance in the soil is, however, of decisive importance for the preservation of fertility. For this reason humus-forming organic substance is added time and again at regular intervals as a soil improving measure. Animal manure has proved to be especially suitable. However, handling animal manure requires a great deal of work and the stench can cause nuisance, particularly in allotments.

For this reason, different methods for the treatment of animal manure have become known to improve handling of this valuable organic substance. For instance, German patent 23 34 494 discloses a method for producing granulated fertiliser from animal dung. According to this method, animal dung is at first ground to form a homogeneous, thin mash; then this mash is converted into granular material which is then dried. In accordance with the described method, several processing steps are required: grinding, drying and granulating. The method described there has different disadvantages. There is the danger that due to the intensive treatment, the nutrients composition can unfavourably change during the intensive drying in fluidized bed at over 100 degrees Celsius when making the mash and due to the necessity of adding moisture again and again to prepare the mass for granulation. Moreover, this method requires a great deal of energy.

In the German published application 26 42 332 a method for drying wet fertilisers, such as horse manure, chicken dung and cow dung, is described. By this method, the wet fertilisers are mixed with quick lime. The mixture is then sifted, salted, ground, and processed to be used as fertiliser. The disadvantages of this procedure consist particularly in the fact that adding a relatively aggressive substance, as quick lime, means an increased effort in the production process. In addition, the pH value is shifted strongly to the alkaline range so that this fertiliser cannot be used everywhere. Moreover, the high pH value of the in the fertiliser can lead to fixation of important micro-nutrients.

In DE 36 09 162 A1, another fertiliser and a method for its production on the basis of animal dung is described. The method uses horse manure which is processed together with straw and, if necessary, further additions of synthetic or natural fertilisers. In particular, damp horse manure is used as initial material to which straw or other supplements, like loose garden peat, chemical fertiliser and other animal dung is added. The disadvantage of this natural fertiliser made of horse manure is that particularly the addition of straw retards decomposition of the natural fertiliser. Moreover, straw is regarded a nitrogen-consuming organic material so that this important nutrient would be lost for the fertilizing.

The object of the invention is to provide a natural fertiliser based on horse manure and a method for producing said fertiliser, which shall be simple and cost-effective, ecologically harmless and have good application properties.

This object is achieved by the characteristics of claims 1 and 22 or 43.

Advantageous further embodiments are indicated in the sub-claims.

According to the present invention, the method for producing a drillable natural fertiliser which consists of horse manure is characterized in that the pieces of horse manure (horse droppings) are collected and processed within a specific time frame determined by preserving the natural humidity and loose structure of the horse droppings as much as possible. An intermediate storage of the horse droppings is imaginable to be able to accumulate optimal quantities for the further processing. The intermediate storage can already be used for initial drying. Attention has to be paid to that the horse droppings are separated from other material occurring usually with the horse manure, like straw and urine straw.

Hay, another typical addition to the dung, should also be removed. Weeds seeds possibly present are thus largely eliminated. This complex cellulose material which is difficult to decompose would consume nitrogen in the decomposition process and is advantageously removed. Separation of the horse droppings from the additives is rather labour consuming; it can be avoided if devices for receiving the horse droppings are used, particularly while keeping the horses in the stable.

Processing the horse droppings according to the present invention will destroy their particular structure and crush them roughly.

As a rule, the horse droppings are picked up from the litter, stored intermediately and processed within one week. Collecting the horse droppings from the grazing area is also feasible. The time from the excretion of the pieces of horse manure to their collection should not exceed one week on an average. The weather has particularly to be taken into account to prevent losses in components and protect the soil-improving micro-organisms in the horse manure. It has proved to be very useful not to wait with processing the horse dropping in summer longer than 24 hours to avoid accelerated drying. Exposure to continuous rain should also be prevented. Residues of up to approx. 1% straw or hay are unobjectionable for the natural fertiliser according to the present invention. Ordinary horse manure which consists of straw, urine straw and pieces of horse manure must be prepared by a suitable separating system so that the horse droppings can be separated from the other constituents.

The required preliminary mechanical disintegration of the horse dropping structures can be done by means of appropriate devices, as fast running rake-like machines.

In another embodiment of the invention the preliminary disintegration is suggested to be made with the aid of animals. The horse droppings are thereby spread out and, e.g., domestic chickens are brought into contact with this area. It is thereby useful to have this “animal-aided” disintegration done in a well ventilated covered room.

It has been demonstrated that chickens are ready and able to crush the horse droppings. The dung excreted by them is also heated dung like horse manure and corresponds thus to the character of a fertiliser on horse manure. The chickens should be kept in a deep-litter system for this purpose. They should be granted sufficient opportunity to rest and suitable running space and fed as ordinary laying hens.

According to the present invention, the next processing step is drying the crushed horse droppings. Drying is exclusively by air drying. Feasible is air drying on flat roofed surfaces, or airy sun drying without exposing the material more than moderate heat and without bleaching it, or air drying on grating pervious to air. The procedure according to the present invention has the great advantage that no additional energy needs to be supplied for the drying and that the drying, as a rule, proceeds at temperatures below 40 degrees Celsius. With direct and intensive sun irradiation temperatures can also become a little higher for a short time. In this case the material must be turned over frequently to prevent overheating. Intensive sun irradiation or other heat actions in connection with washouts caused by rain action result in bleached material that cannot be used as a fertiliser any more. The drying process should continue until the crushed horse droppings have lost approx. 50% of their natural humidity. In particularly unfavourable weather conditions it might be appropriate to use arising waste heat for the drying of the material.

The roughly crushed and initially dried material can be collected by means of a blower vacuum shredder, for example. The loose shredded material is then further air-dried until its residual moisture has dropped to approx. 5%

In another embodiment of the invention the horse droppings are processed within one week from the time of excretion. This processing time frame should particularly be set if weather impacts, like rain and strong sun irradiation, change the horse droppings adversely.

In another embodiment of the invention the horse droppings are processed within six months, provided that weather impacts, like temperature, humidity and sun irradiation, are excluded. After that time, structural changes are to be expected which can affect the quality of the fertiliser adversely.

In another embodiment of the invention the initially dried material is fed into an extruder for producing pressed granular material. The grain size amounts to 4 to 10 mm with a portion of fragments and powder of 10% at most. The granular material thus produced is subsequently air-dried until its residual moisture has dropped to 5%. Micro-organisms can be added beneficially to the granular material, but just as well the shredded material, for their beneficial influence on the disintegration process and the release of the nutrients, i.e. their conversion into a form available to the plants.

The natural fertiliser produced by the method according to the present invention is distinguished by its very good user friendliness. Both the chaff and the granular material could be delivered in bags. Other forms of delivery are also possible, of course.

The granular fertiliser material shows beneficial good water storage capacity due to its structure and porosity. Worked into the soil, it produces heat which proves that the microbiological activity inherent in the basic material has remained unchanged even after the production process.

The natural fertiliser according to the present invention is suitable for being spread on the areas under cultivation. It suffices to work the fertiliser in into the upper layer of the soil by means of a rake. Unlike working in animal dung, little effort is required. The natural fertiliser according to the present invention is fast available as a nutrient supplier due to his easy and, above all, speedier decomposition (as a result of the production process according to the present invention). The natural fertiliser can be brought in timely, for instance before the planting or sowing. The granular material can also be used very advantageously for roses, strawberries and vegetable plots, but also as a top fertiliser for fruit-trees and decorative bushes.

The natural fertiliser according to the present invention consists of formed and broken horse droppings material and contains among other things essential trace elements, the concentration of which in the soil has fallen off in the soil and particularly on areas intensively used. It contains important primary nutrients, as nitrogen and phosphorus, besides such important micro-nutrients like selenium and iodine. The nutrient content can be increased by enriching the horse droppings with horse urine. Horse urine should be added best at the beginning of the drying process. The basic consistency supports breaking up of the upper layers of the soil and enhances water storage. The granular material is relatively heavy and can be spread without being worked in. The natural fertiliser is odourless and dry and thus very comfortable in its application. The decomposition process produces heat, which can be important particularly in the transitional seasons. The enrichment of the fertiliser with more micro-organisms can meaningfully add to the qualities. The micro-organisms can be liquidized and sprayed on or in prior to collecting and packing the material, avoiding, however, that the material is soaked through again.

In the following the invention is described in greater detail by means of an exemplary embodiment.

The production of shredded or granulated horse manure fertiliser depends on whether smaller or larger production units are planned to be used. Processing is mainly particularly manual in small production units while in larger production units it should be mechanical.

In the first stage of the process, the horse droppings are separated from the straw/hay/urine waste of the horse manure, so that exclusively horse droppings are used for the further processing. For the manual separation of the horse droppings suitable metal or plastic pitchforks are used. The horse droppings are picked up from the other dung constituents with the fork, stored and then further processed.

In larger production units the horse manure, which contains straw, hay, wood shavings or similar litter and heavy urine mixture in addition to the horse droppings, is transported by means of a fast running conveyor belt and fed to a blast attached at the end which blows in crossways direction. Due to the acceleration, the heavy horse droppings are separated from the lighter litter. The urine straw also does not fall very far and is removed at the side. The dung to be processed should not be older than one to three weeks, since otherwise separation of the horse droppings would become increasingly difficult with starting decomposition and compaction of the horse droppings. The horse droppings thus separated are then stored intermediately. The time of intermediate storage shall not exceed one week. Longer storage is possible although it would result in quality losses.

In small production units the stored material is picked up and spread on a chicken run. One wheelbarrow load of horse droppings spread on an area of approx. 20 sq m will be crushed by six chickens in a day. The material crushed by the chickens is then sifted out by means of a sieve of a mesh size between 30 and 40 mm. The horse droppings not yet sufficiently crushed are sorted out by hand to remain in the chicken run. The horse droppings crushed to a maximum size of 40 mm are dried to approx. 50% of the original humidity. The drying method depends on the season. The duration of the drying will also depend on the season and on the weather. The humidity can be judged by inspection; exact measuring is not required.

The material thus initially dried is then collected by means of a blower vacuum for leaves of at least 2 kW. The resulting chaff of 20 mm at most is dispersible. The material thus treated can also be fed into an extruder to obtain granulated natural fertiliser.

The horse droppings can be dried in different ways. Drying on concrete surfaces is appropriate particularly at sunshine and low relative humidity. Experience shows that the drying is completed after approx. one day. Depending on the season, the material can be dried in the open or under cover in rainy weather.

So-called rib mesh should the used for drying on grating. The rib mesh should be fastened to a suitable sub-structure and put up at an angle to ensure good ventilation. Provided suitable crossways ventilation the drying is completed within one to 14 days. Longer drying time will be needed at temperatures below the freezing point and at high humidity.

Drying on concrete surfaces in roofed rooms, e.g. in greenhouses, is independent of weather and season. However, this drying method requires frequent turning over of the material, which can be carried out by hand or mechanically.

Drying on or in nets, e.g. scaffold protection nets, requires proper bracing of the nets just over the ground so that they can also be stepped on by the producer. Ventilation from below has to be ensured.

As a rule, drying takes approx. one day for final drying in midsummer, approx. 3-5 days in the transitional period and approx. 3-4 weeks in winter under greenhouse conditions.

Sunshine helps drying although it is not decisive alone. At normal Central European temperatures from spring to autumn the raw material dries also very well and, above all, easily, i.e. without concentrated heat action. Fast and direct drying by means of microwaves or high temperature, for example, would inevitably have an adverse affect on the microbiological activity potential of the fertiliser produced according to the present invention. Preservation of the microbiological flora in the end product is an important advantage of the production process according to the present invention.

Aerated sun drying below 40 degrees Celsius with mild sun irradiation, no overheating and frequent turning over to provide for air access is particularly well suited for the production of the fertiliser according to the present invention.

Generally, the material should also be turned over from time to time during the drying to let developing ammonium nitrogen escape.

Waste heat from biogas plants can be used very advantageously, particularly for ecological reasons. Waste heat from other sources can also be used in the different drying stages, particularly when drying the material on grating. The natural fertiliser thus produced has a residual humidity of approx. 5% and can be handled and transported very well.

It can be filled in bags, for instance in paper bags, which are then closed or sealed by means of a paper bag sewing machine. Paper bags are pervious to air and environmentally friendly. Material filled in paper bags does not go mouldy and preserves the micro-organisms due to the air permeability of the paper bags.

The fertiliser can be filled also in plastic bags, although it should be noted that the residual humidity can cause unwanted microbiological activities in the fertiliser.

The bags are then appropriately labelled, weighed and provided with information for the users particularly concerning the handling of the fertiliser.

Both granulated and not granulated material can be dried in the drying process described. As a rule, drying of granulated material takes less time. As a rule, 30 to 40% less time is required to achieve a residual humidity of 5%.

In the large-scale production of the natural fertiliser according to the present invention, efficient machines are used. The horse droppings are collected by means of efficient leaves vacuum machines. High-performance turbines used, for example, to collect cut grass also suck in horse droppings easily and completely. The grown grass and the soil remain outside the blast. The material is shredded in the same operation.

The high-performance vacuum can be used also after separation of the horse manure into straw and horse droppings, i.e. the external heap of horse droppings is sucked in again and shredded.

In large-scale production it is also possible to distribute the moist material on a concrete surface, for example by means of a tractor with a star tedder attachment. The fertiliser material is turned over repeatedly in a day and dried to apparent 50% humidity. In principle other drying possibilities, as described above, are applicable also here.

Collecting the material once more by means of a high-performance vacuum shredder produces also shredded material. The material can then be sucked in and spread out again on the same area. Since quite a lot of dust is generated in this process, it is recommended, if the nuisance caused by the dust gets too big, to use grass trap devices and distribute these by means of the star tedder once more.

In large-scale production the initially dried or dried material is also fed into an extruder. The extruded material is then cut into short pieces and spread on the ground as granulated material. Initially dried whole horse droppings can also be used here. Enrichment with an adequate quantity of horse urine is advisable and improves both the structure and the dispersibility of the produced granular material. Humidity of the material must not exceed 20%. The shredded or granulated natural fertiliser is dried to a residual humidity of 5%, collected by means of tractors and filled in bags mechanically.

The remaining material separated from the horse droppings, usually straw, hay, grass, weed seeds, and often different kinds of litter, can be composted. As a matter of course, the relevant environmental protection ordinances have to be taken into account when further composting such material, e.g. in old silage plants.

The use of earthworms can be helpful. In this case contact to the soil, i.e. the surrounding microbiological environment must be ensured. Thus decomposition takes place quickly.

To shorten the processing time, the litter, if it is not yet decayed too much, should be collected by means of a blower vacuum shredder. The material can then be brought to the silage plant with soil contact to be decomposed. The resulting advantageous by-product is humus rich soil.

The fertiliser can be enriched with micro-organisms by means of suitable spraying methods.

In small-size production the micro-organisms can be dispersed by means of a spraying bottle prior to filling the natural fertiliser in bags.

In large-scale production a mechanical fertiliser sprayer should be used. The minimum humidity, however, should not be exceeded.

1. A method for producing a dispersible natural fertiliser from horse manure, characterized in that
the horse droppings excreted by horses are collected and processed within a certain time frame which covers preservation of a natural humidity and loose structure of the horse droppings as much as possible.

2. A method according to claim 1, characterized in that
the horse droppings are separated from other constituents present in the horse droppings.

3. A method according to claim 1, characterized in that
a particular structure of the horse droppings is destroyed and the horse droppings are crushed roughly.

4. A method according to claim 1, characterized in that
the horse droppings are crushed mechanically.

5. A method according to claim 1, characterized in that
the horse droppings are spread prior to the mechanical crushing.

6. A method according to claim 1, characterized in that
the horse droppings are crushed mechanically by a blower vacuum shredder.

7. A method according to claim 1, characterized in that
the horse droppings are crushed by animals.

8. A method according to claim 1, characterized in that
the horse droppings are crushed by domestic chickens.

9. A method according to claim 8, characterized in that
the chickens used are kept in a ventilated, closed room and in a deep-litter system.

10. A method according to claim 1, characterized in that
the crushed horse droppings are crushed and dried.

11. A method according to claim 1, characterized in that
the horse droppings are crushed and air dried or dried in the sun with aeration.

12. A method according to claim 1, characterized in that
the air drying takes place on flat, roofed surfaces or on grating pervious to air.

13. A method according to claim 1, characterized in that
the horse droppings are initially dried until humidity has dropped by approximately 50%.

14. A method according to claim 1, characterized in that
the initially dried horse droppings are roughly crushed and finally dried to a residual humidity of approximately 5% to produce chaff.

15. A method according to claim 1, characterized in that
a granular material is produced from initially drying and crushing horse droppings.

16. A method according to claim 15, characterized in that
the granular material is produced in an extruder.

17. A method according to claim 16, characterized in that
the horse droppings are not crushed prior to the extrusion.

18. A method according to claim 15, characterized in that
the horse droppings are finally dried after granulation to a residual humidity adjusted to approximately 5%.

19. A method according to claim 1, characterized in that
the horse droppings are processed within one week from when they are excreted.

20. A method according to claim 1, characterized in that
the horse droppings are processed within six months, excluding weather impacts like temperature, humidity and sun irradiation.

21. A method according to claim 1, characterized in that
at least one micro-organism is added.

22. A natural fertiliser, produced by
collecting horse droppings and processing these within a certain time frame which covers preservation of a natural humidity and loose structure of the horse droppings as much as possible.

23. A natural fertiliser according to claim 22, produced by
separation of an other constituent present from the horse droppings.

24. A natural fertiliser according to claim 22, produced by
destroying a particular structure of the horse droppings and crushing them roughly.

25. A natural fertiliser according to claim 22, produced by
mechanical crushing of the horse droppings.

26. A natural fertiliser according to claim 25, produced by
spreading the horse droppings prior to crushing them mechanically.

27. A natural fertiliser according to claim 26, produced by
crushing the spread horse droppings mechanically by a blower vacuum shredder.

28. A natural fertiliser according to claim 22, produced by
using animals to crush the horse droppings.

29. A natural fertiliser according claim 22, produced by
the use of domestic chickens to crush the horse droppings.

30. A natural fertiliser according to claim 22, produced by
the use of chickens kept in an airy, closed deep-litter room.

31. A natural fertiliser according to claim 22, produced by
crushing and drying the horse droppings.

32. A natural fertiliser according to claim 31, produced by
drying the crushed horse droppings by air drying or ventilated sun drying.

33. A natural fertiliser according to claim 22, produced by
air drying the horse droppings on flat, roofed areas or on grating pervious to air.

34. A natural fertiliser according to claim 22, produced by
initially drying the horse droppings to a reduction in humidity of approximately 50%.

35. A natural fertiliser according claim 22, produced by
final drying of the initially dried and roughly crushed horse droppings to a residual humidity of approximately 5% for producing chaff.

36. A natural fertiliser according to claim 22, produced by
granular material production from partially dried and crushed horse droppings.

37. A natural fertiliser according to claim 22, produced by
making a granular material in an extruder.

38. A natural fertiliser according to claim 37, produced by
extruding the horse droppings without prior crushing.

39. A natural fertiliser according to claim 37, produced by
final drying of the granulated material to an adjusted residual humidity of approximately 5%.

40. A natural fertiliser according to claim 22, produced by
processing of the horse droppings within one week from the time of their excretion.

41. A natural fertiliser according to claim 22, produced by
processing the horse droppings within six months under exclusion of the impacts of weather.

42. A natural fertiliser according to claim 22, produced by
adding micro-organisms.

43. A natural fertiliser consisting of formed and dried horse droppings material.

44. A natural fertiliser according to claim 43, characterized in that
at least one micro-organism is contained in the fertilizer.

45. A natural fertiliser according to claim 43, characterized in that
the horse droppings material is granulated.

46. A natural fertiliser according to claim 43, characterized in that
the horse droppings material is adequately chopped to form chaff.

47. A natural fertiliser according to claim 43, characterized in that
it contains less than 5% residual humidity.

48. A method according to claim 21, wherein the micro-organism comprises at least one of lactic acid bacteria, photo synthesis bacteria, yeasts, actiomycetes and noble mould.

49. A natural fertiliser according to claim 23, wherein the other constituent present comprises at least one of straw, urine straw, other litter and foreign matter.

50. A natural fertiliser according to claim 42, wherein the micro-organism comprises at least one of lactic acid bacteria, photo synthesis bacteria, yeasts, actiomycetes and noble mould.

51. A natural fertiliser according to claim 44, wherein the micro-organism comprises at least one of lactic acid bacteria, photo synthesis bacteria, yeasts, actiomycetes and noble mould.
